(19) United States
(12) Patent Application Publication
(10) Pub. No.: US 2014/0067827 A1
(43) Pub. Date: Mar. 6, 2014

(54) AUTOMATICALLY GENERATING MUSIC PLAYLISTS BASED ON AN IMPLICITLY SELECTED SEED

(71) Applicant: Google Inc., Mountain View, CA (US)

(72) Inventors: Brandon Bilinski, San Francisco, CA (US); Owen Daniel Otto, Oakland, CA (US)

(21) Appl. No.: 13/650,611

(22) Filed: Oct. 12, 2012

Related U.S. Application Data
(60) Provisional application No. 61/697,051, filed on Sep. 5, 2012.

(51) Int. Cl. G06F 17/30

(52) U.S. Cl. 707/748; 707/736; 707/E17.033; 707/E17.009

(57) ABSTRACT

A method for generating a playlist may include automatically selecting a plurality of seed songs from a music library based on at least one selection criteria associated with song popularity. The at least one selection criteria may be selected (e.g., randomly) from a plurality of available selection criteria. One of the plurality of seed songs may be selected (e.g., randomly). A first playlist with a plurality of songs from the music library may be generated. The plurality of songs in the first playlist may be automatically selected to be similar to the selected one of the plurality of seed songs. The at least one selection criteria may include one or more of a highest song rating, frequency of song playback within a determined time period, recent song purchase, and social media posting by a user regarding a song from the music library.

### CROSS-REFERENCE TO RELATED APPLICATIONS/INCORPORATION BY REFERENCE

This application makes reference to and claims priority to U.S. Provisional Application Ser. No. 61/697,051, filed on Sep. 5, 2012, entitled “AUTOMATICALLY GENERATING MUSIC PLAYLISTS BASED ON AN IMPLICITLY SELECTED SEED,” which is incorporated herein by reference in its entirety.

### TECHNICAL FIELD

Aspects of the present application relate generally to the field of processing digital media content. More specifically, certain implementations of the present disclosure relate to system and/or method for automatically generating music playlists based on an implicitly selected seed.

### BACKGROUND

Users frequently want to quickly start playing an enjoyable mix of music with a minimum of effort spent selecting what to play. There are existing solutions for automatically creating a playlist based on a user selected seed song, from which similar songs are chosen by a music-management system in order to populate the playlist. For example, manually-seeded music services, such as Pandora and iTunes Genius, require the user to select a seed song so that a playlist can be created. However, with the continuously growing personal music libraries, the manual selection of seed songs still requires a fair amount of user effort and time to navigate through their music collection and select an appropriate seed song.

Further limitations and disadvantages of conventional and traditional approaches will become apparent to one of skill in the art, through comparison of such approaches with some aspects of the present method and apparatus set forth in the remainder of this disclosure with reference to the drawings.

### BRIEF SUMMARY

A system and/or method is provided for automatically generating music playlists based on an implicitly selected seed, substantially as shown in and/or described in connection with at least one of the figures, as set forth more completely in the claims.

In accordance with an embodiment of the disclosure, a method for generating a playlist may include automatically selecting a plurality of seed songs from a music library based on at least one selection criteria associated with song popularity. The at least one selection criteria may be selected (e.g., randomly) from a plurality of available selection criteria. One of the plurality of seed songs may be selected (e.g., randomly). A first playlist with a plurality of songs from the music library may be generated. The plurality of songs in the first playlist may be are automatically selected to be similar to the selected one of the plurality of seed songs.

The at least one selection criteria may include one or more of a highest song rating, frequency of song playback within a determined time period, recent song purchase, and social media posting by a user regarding a song from the music library. A second playlist may be generated from the music library based on another selected one of the plurality of seed songs. The first and second playlists may be communicated to a user device for display. A combined music art icon of the first playlist may be generated for display at a user device. The combined music art icon may include music art for each of the plurality of songs in the first playlist.

The method may further include causing display of the combined music art icon at the user device. The display may include an indication of the at least one selection criteria and the selected one of the plurality of seed songs. A score may be assigned to each song in the music library based on whether the song satisfies the at least one selection criteria. The plurality of seed songs may be selected by selecting a determined number of songs from the music library based on a maximum assigned score. A user notification of the generated first playlist may be sent to a user device. In response to an input from the user, the first playlist may be saved in memory for subsequent use by the user. A new playlist with a plurality of songs from the music library may be generated. The plurality of songs in the new playlist may be automatically selected to be similar to a new selected (e.g., randomly) one of the plurality of seed songs. The generating of the new playlist may take place upon restarting of the user device.

In accordance with another embodiment of the disclosure, a system for generating a playlist may include one or more circuits comprising in a network device, the one or more circuits may be operable to automatically select a plurality of seed songs from a music library based on at least one selection criteria associated with song popularity. The at least one selection criteria may be selected (e.g., randomly) from a plurality of available selection criteria. One of the plurality of seed songs may be selected (e.g., randomly). A first playlist with a plurality of songs from the music library may be generated. The plurality of songs in the first playlist may be automatically selected to be similar to the selected one of the plurality of seed songs.

The at least one selection criteria may include one or more of a highest song rating, frequency of song playback within a determined time period, recent song purchase, and social media posting by a user regarding a song from the music library. The one or more circuits may be operable to generate a second playlist from the music library based on another selected (e.g., randomly) one of the plurality of seed songs. The first and second playlists may be communicated to a user device for display. The one or more circuits may be operable to generate a combined music art icon of the first playlist for display at a user device. The combined music art icon may include music art for each of the plurality of songs in the first playlist.

The one or more circuits may be operable to cause display of the combined music art icon at the user device. The display may include an indication of the at least one selection criteria and the selected one of the plurality of seed songs. The one or more circuits may be operable to assign a score to each song in the music library based on whether the song satisfies the at least one selection criteria. The one or more circuits may be operable to select the plurality of seed songs by selecting a determined number of songs from the music library based on a maximum assigned score. The one or more circuits may be operable to send a user notification of the generated first playlist to a user device, and in response to an input from the user, save the first playlist in memory for subsequent use. The one or more circuits may be operable to generate a new playlist with a plurality of songs from the music library. The plurality of songs in the new playlist may be automatically selected to be similar to a new selected one of the plurality of seed songs (e.g., randomly selected), and the generating of the new playlist may take place upon restarting of the user device.

In accordance with yet another embodiment of the disclosure, a method for generating a playlist may include selecting (e.g., randomly) a plurality of selection criteria associated with song popularity. At least one of the plurality of selection criteria may be based on a user interaction on a social web site regarding at least one of a plurality of songs in a music library. A score may be assigned to each of the plurality of songs in the music library based on the at least one selection criteria. The plurality of songs in the music library may be ranked according to the assigned score. A determined number of top ranked songs may be selected from the ranked plurality of songs as a plurality of seed songs. At least one playlist with a plurality of songs from the music library may be generated. The plurality of songs in the at least one playlist may be automatically selected to be similar to a selected (e.g., randomly) at least one of the plurality of seed songs. The plurality of songs in the at least one playlist may also be automatically selected to be similar to a randomly selected at least two of the plurality of the seed songs.

These and other advantages, aspects and features of the present disclosure, as well as details of illustrated implementation(s) thereof, will be more fully understood from the following description and drawings.

### BRIEF DESCRIPTION OF SEVERAL VIEWS OF THE DRAWINGS

FIG. 1 is a block diagram illustrating example architecture for automatically generating music playlists, in accordance with an example embodiment of the disclosure.

FIG. 2 is a block diagram illustrating automatically generating music playlists based on an implicitly selected seed, in accordance with an example embodiment of the disclosure.

FIG. 3 is a block diagram illustrating an example graphical user interface (GUI) used with automatically generated music playlists, in accordance with an example embodiment of the disclosure.

FIG. 4 is a flow chart illustrating example steps of a method for generating a playlist, in accordance with an example embodiment of the disclosure.

FIG. 5 is a flow chart illustrating example steps of another method for generating a playlist, in accordance with an example embodiment of the disclosure.

### DETAILED DESCRIPTION

As utilized herein the terms “circuits” and “circuitry” refer to physical electronic components (i.e. hardware) and any software and/or firmware (“code”) which may configure the hardware, be executed by the hardware, and or otherwise be associated with the hardware. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the term “e.g.,” introduces a list of one or more non-limiting examples, instances, or illustrations.

As used herein the terms “media”, “digital media” or “digital media item” may include any discrete media object, such as streaming media, audio files (e.g., songs), video files, games, slide shows, camera captures, and the like. Such digital media may be played back, displayed, or otherwise rendered for a user to consume the digital media.

The present disclosure relates to a method and system for automatically generating music playlists based on an implicitly selected seed. In various implementations, to facilitate the selection of a seed song, a digital media interface may be used to present the user with automatically-generated playlists created based on seed songs selected by a media backend. Each seed song may be selected based on user-behavior, which indicates affinity for a given digital media item (e.g., a song).

For example, a method for generating a playlist may include automatically selecting a plurality of seed songs from a music library based on at least one selection criteria associated with song popularity. One of the plurality of seed songs may be selected (e.g., randomly). A first playlist with a plurality of songs from the music library may be generated. The plurality of songs in the first playlist may be automatically selected to be similar to the selected one of the plurality of seed songs. The at least one selection criteria may include one or more of a highest song rating, frequency of song playback within a determined time period, recent song purchase, and social media posting by a user regarding a song from the music library. A second playlist from the music library may be generated based on another selected one of the plurality of seed songs (e.g., randomly selected).

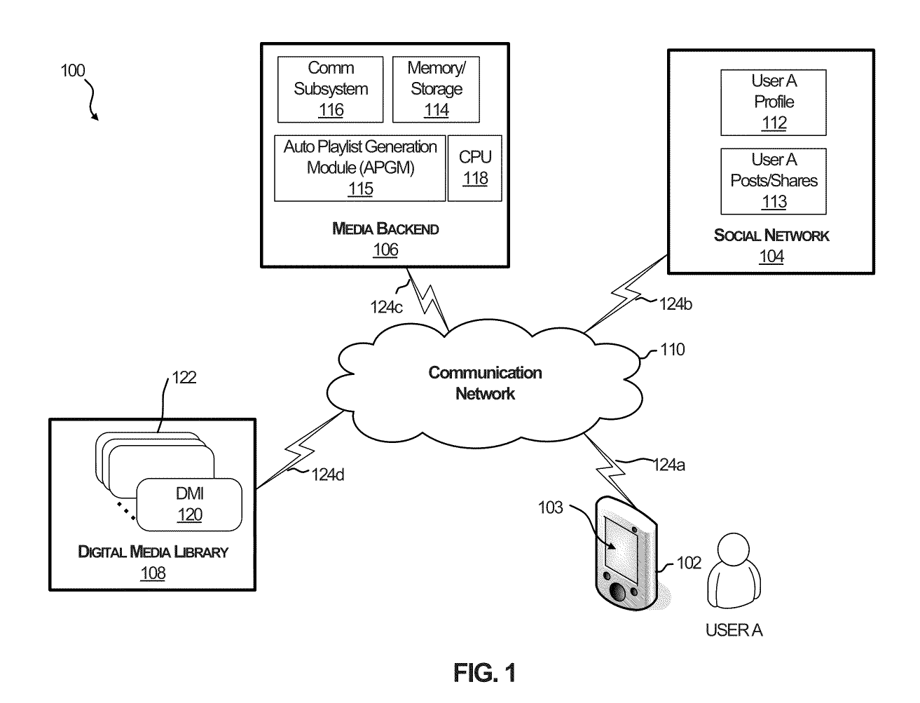

FIG. 1 is a block diagram illustrating example architecture for automatically generating music playlists, in accordance with an example embodiment of the disclosure. Referring to FIG. 1, the example architecture 100 may comprise a client device 102 of a user (e.g., User A), a social network 104, a media backend 106, and a digital media library 108.

The client device 102 may comprise suitable circuitry, logic and/or code and may be operable to communicate with the social network 104, the media backend 106 and/or the digital media library 108 to receive one or more digital media items, which may be organized in automatically generated playlists. Additionally, the client device 102 may be operable to render or format the received one or more digital media items for consumption by User A. For example, if the digital media item comprises a music file (e.g., a song), the client device 102 may receive and display an automatically generated playlist associated with the music file on the device display 103. The client device may also play the received music file for user A using device speakers or external speakers. The client device 102 may comprise a handheld computing device (e.g., a cell phone, a smart phone, a personal data assistant (PDA), a tablet), a set-top box device, a laptop computer or another computing device.

Furthermore, the client device 102 may also include one or more transceivers for providing wired and/or wireless communication of data via the communication links 124a-124d. In this regard, the communication links 124a-124d may comprise one or more wired and/or wireless communication links used to communicate data via the communication network 110.

The communication network 106 may comprise the Internet as well as any combination of wired and/or wireless networks, such as a Wi-Fi network, a WiMAX network (or another 802.1x enabled network), a satellite network, or a cellular telephone network.

The media backend 106 may comprise suitable circuitry, logic and/or code and may be operable to provide digital media related services to the client device 102. For example, the media backend 106 may provide digital media storage and management services, subscription services (e.g., streaming media subscription services), and digital media provisioning services (e.g., automatically generating playlists from a digital media library, as well as sale, transcoding and download of digital media). The media backend 106 may also comprise memory/storage 114, a communication subsystem 116, an automatic playlist generation module (APGM) 115, and a central processing unit (CPU) 118. Additionally, the media backend 106 may operate as, for example, a streaming content provider and may be operable to keep track of each digital media item that a user (e.g., user A) has viewed or listened to. In this regard, the media backend may store a play or view count of digital media items in the memory/storage block 114, as well as metadata information associated with digital media items from the digital media library 108 (e.g., rating, frequency of play, date of purchase/download or other metadata indicating user affinity to a specific digital media item).

Even though the media backend 106 is illustrated as being separate from the user device 102, the disclosure may not be limited in this regard. More specifically, the media backend 106 may be implemented as part of the user device 102 or another computing device of user A.

The communication subsystem 116 may comprise suitable circuitry, logic, and/or code and may be operable to provide communication of information to and from the digital media library 108, the social network 104, and/or the client device 102. For example, the communication subsystem 116 may include one or more transceivers for providing wired and/or wireless communication of data to and from the digital media library 108 (via the wired and/or wireless communication link 124d), and/or the client device 102 or the social network 104 via the communication network 106 and the communication links 1124c, 124a, and 124b.

The automatic playlist generation module (APGM) 115 may comprise suitable circuitry, logic and/or code and may be operable to automatically generate one or more playlists of digital media items selected from the digital media library 108. More specifically, the APGM 115 may be operable to automatically select a seed (e.g., a seed song) based on user behavior indicating affinity to certain digital media, and then generate one or more playlists based on the seed. The playlists may be communicated to the user device 102 for display on the screen 103 and consumption of the corresponding digital media in the playlist by user A.

The digital media library 108 may comprise suitable circuitry, logic and/or code and may be operable to manage a plurality of digital media items (DMIs) 120, . . . , 122. The plurality of DMIs 120, . . . , 122 may comprise a plurality of songs forming a personal music library of user A. Even though the digital media library 108 is illustrated as being separate from the media backend 106, the disclosure may not be limited in this regard. More specifically, the digital media library 108 may be implemented as part of the media backend 106 or the user device 102.

The social network 104 may comprise suitable circuitry, logic and/or code and may be used by the media backend 106 during the automatic generation of the playlists of digital media items by the APGM 115. More specifically, the social network 104 may comprise a profile 112 and online posts/shares 113 of user A. The APGM 115 may communicate with the social network 104 (via communication links 124c, 124b and communication network 110), and obtain digital media related information from the profile 112 and/or the posts/shares 113. Such information may indicate affinity of user A to certain digital media item(s) from the plurality of DMIs 120, . . . , 122 stored in the digital media library 108. For example, the APGM 115 may obtain information related to user A's posts or shares or profile-specific preferences related to a digital media genre (e.g., a specific type of music user A likes) or a specific digital media item user A likes (e.g., a recently heard or purchased song). This digital media related information may then be used by the APGM 115 for the automatic selection of a seed digital media item (e.g., one or more seed songs) and generating the playlist for user A.

In operation, user A may use the client device 102 to subscribe to a digital media provisioning and management service provided by the media backend 106. As part of the digital media provisioning and management service, user A may purchase, download, store, organize and generally have access to a plurality of digital media items 120, . . . , 122 stored in the digital media library 108. For example, user A may have access to digital media items 120, . . . , 122, which may comprise one or more streaming videos, songs or other types of digital media items. Additionally, user A may have previously purchased (or downloaded) the digital media items 120, . . . , 122, and may download (and store) any of the digital media items 120, . . . , 122 locally at the client device 102, or at a cloud-based digital media locker service.

Additionally, as part of the digital media related services provided by the media backend 106, the APGM 115 may automatically generate a list with a plurality of digital media seeds (e.g., seed songs) based on user A's affinity for certain digital media items within the digital media library 108. The APGM 115 may then generate one or more playlists based on at least one digital media seed selected (e.g., randomly) from the generated plurality of digital media seeds. The generated playlists may be communicated to the user device 102 and may be automatically displayed on the screen 102 as soon as the user device 102 is turned ON or user A accesses digital media management functionalities provided by the media backend 106 (e.g., user A accesses a music or other digital media online store or digital media collection management functionalities related to user A's digital media collection of items 120, . . . , 122).

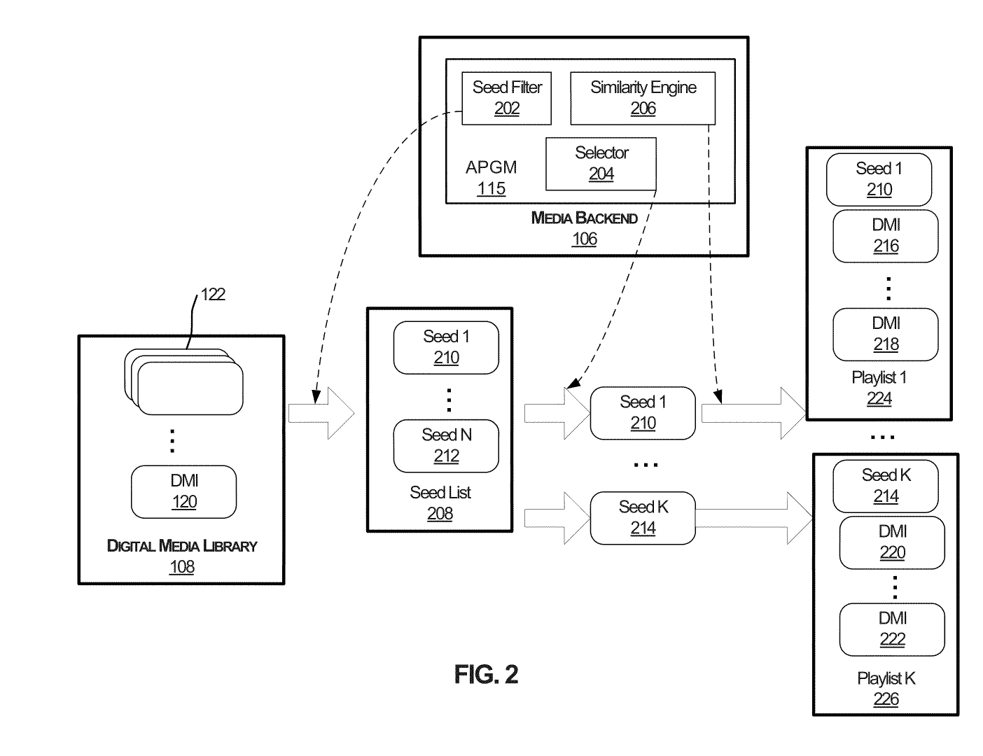

FIG. 2 is a block diagram illustrating automatically generating music playlists based on an implicitly selected seed, in accordance with an example embodiment of the disclosure. Referring to FIG. 2, there is illustrated an example process of automatic generation of music playlists by the APGM 115, based on one or more implicitly selected seeds.

The APGM 115 may comprise a seed filter 202, a selector module 204, and a similarity engine 206, which may be used during the automatic generation of playlists. More specifically, the seed filter 202 may comprise suitable circuitry, logic and/or code and may be operable to use implicit information from a user's digital media library to generate one or more seed list. More specifically, the seed filter 202 may use one or more selection criteria associated with digital media (e.g., song) popularity, as well as user behavior that indicates affinity to specific digital media, for selecting a seed list from the digital media library 108. For example, the seed filter 202 may use the following selection criteria associated with user affinity to a song during the seed list selection:

Song rating (e.g., the user gave the song a high rating, such as recent “thumbs up” or 4-5 stars);

High play count (e.g., the user has played the song more than X times in a given time period);

Recently purchased (e.g., the user has recently purchased a song);

“Old favorite” song (e.g., the user has listened to the song more than X times in the past, but has not heard the song in the last certain number of days/weeks/months);

Social network popularity (e.g., the user's friends with similar music tastes have listened to the song more than X times in a given time period); and

Genre Popularity (e.g., the user owns or listens to a lot of music from a specific genre).

In accordance with an embodiment of the disclosure, the seed filter 202 may use the above criteria as well as other selection criteria associated with user affinity to a song in order to select a seed list from the digital media library 108. Based on the selection criteria selected, the seed filter 202 may assign weights (or scores) for each song in the user A's digital media library of DMIs 120, . . . , 122. The seed filter 202 may use one or more of the selection criteria at any given time, where the one or more selection criteria may be selected (e.g., randomly) by the CPU 118, or may be pre-selected by user A.

For example, if “song rating” and “social network popularity” are selected as filtering criteria, the seed filter 202 may obtain metadata information associated with song rating for each of DMIs 120, . . . , 122. If the song rating for a song is above a certain threshold, then the song may be assigned certain weight (or score). The seed filter 202 may then obtain “social network popularity” information based on profile information 112 and/or posts/shares information 113 associated with user A on the social network 104. For example, user A may have a post that he enjoys classical music. The seed filter 202 may then assign an additional weight (or score) to all classical music tracks within the DMIs 120, . . . , 122. The seed filter 202 may then rank the DMIs 120, . . . , 122 according to total score and may select a determined number of the top scoring DMIs (e.g., songs with the highest weight or score given) as the seed list.

The selector module 204 may comprise suitable circuitry, logic and/or code and may be operable to perform a selection of one or more seed songs from the seed list generated by the seed filter 202. For example, the selector module 204 may be operable to perform a random selection of one or more seed songs from the seed list generated by the seed filter 202.

The similarity engine 206 may comprise suitable circuitry, logic and/or code and may be operable to generate a playlist based on a seed song or metadata from the seed song. More specifically, after receiving a seed song (or metadata from the seed song), the similarity engine 206 may generate a playlist with a determined number of songs selected from, for example, the DMIs 120, . . . , 122 in the digital media library 108. The determined number of songs may be selected based on similarity to the received seed song. Various techniques may be used in selecting songs similar to the seed song, such as acoustic similarity, genre similarity, artist similarity, as well as other techniques.

Even though the seed filter 202, the selector module 204 and the similarity engine 206 are illustrated as implemented within the media backend 106, the present disclosure may not be limited in this regard. More specifically, the seed filter 202, the selector module 204 and the similarity engine 206 may be implemented as separate functional modules or as part of other network devices.

In operation, the seed filter 202 in the media back end 106 may find seed tracks based on implicit information from user A's digital media library (e.g., DMIs 120, . . . , 122). More specifically, the seed filter 202 may select (e.g., randomly) one or more of the selection criteria described above (or other similar criteria) and apply the selection criteria to the DMIs 120, . . . , 122 in the digital media library 108. After applying the selection criteria, a seed list 208 may be generated with seed songs 210, . . . , 212 that have the highest weight (or score) after applying the selection criteria. The selector module 204 may randomly select one or more of the seed songs (e.g., 210, . . . , 214), which may be used by the similarity engine to generate corresponding playlists 224, . . . , 226 based on selected seeds 210, . . . , 214.

The playlists 224, . . . , 226 may be generated as a background process to the user device 102, based on metadata, play/purchase history, social signals (e.g., from the social network 104) or other implicit information from a user's digital media library to generate one or more seeds, and at least one playlist from the one or more seeds.

For example, the seed filter 202 may use the “recently purchased song” selection criteria (or filter). The seed filter 202 may then search the DMIs 120, . . . , 122 for the most recently purchased song. The most recently purchased song will be selected as the seed song (e.g., seed 210). Metadata associated with the seed song 210 may then be communicated to the similarity engine 206 to generate a playlist (e.g., playlist 224), which may include the seed song (seed 210) and additional songs (216, . . . , 218) which are similar to the seed. The one or more generated playlists (e.g., 224, . . . , 226) may be communicated to the user device 102 and displayed to user A the next time the user device 102 is turned ON and user A logs into digital media storage/management services platform of the media backend 106.

In accordance with an example embodiment of the disclosure, more than one selection criteria may be used, and each playlists may combine songs that are similar to a plurality of selected seeds, instead of just one seed. For example, the seed filter 202 may use the “recently purchased song” and the “total play count” (or “high play count”) selection criteria (or filters). The seed filter 202 may then search the DMIs 120, . . . , 122 for the most recently purchased songs (e.g., the top 100 most recently purchased songs). The seed filter 202 may then search the top 100 most recently purchased songs for the songs with the highest play count and most recently purchased songs (e.g., the top 50 highest play count songs). The highest play count song (after “recently purchased song” filter has been applied) may be selected as the seed song (e.g., seed 210). Metadata or social network related information (e.g., 112, 113) associated with the seed song 210 may then be communicated to the similarity engine 206 to generate a playlist (e.g., playlist 224), which may include the seed song (seed 210) and additional songs (216, . . . , 218) which are similar to the seed 210. The one or more generated playlists (e.g., 224, . . . , 226) may be communicated to the user device 102 and displayed to user A the next time the user device 102 is turned ON and user A logs into digital media storage/management services platform of the media backend 106.

In accordance with another example embodiment of the disclosure, each of the playlists 224, . . . , 226 may include songs from the corresponding seed for that playlist as well as songs from another seed from the seed list 208. For example, playlist 224 may include the seed song (seed 210) and additional songs (216, . . . , 218) which are similar to the seed 210. However, playlist 224 may also include additional songs (e.g., one or more of DMIs 220, . . . , 222), which are similar to another seed (e.g., seed 214) from the seed list 208.

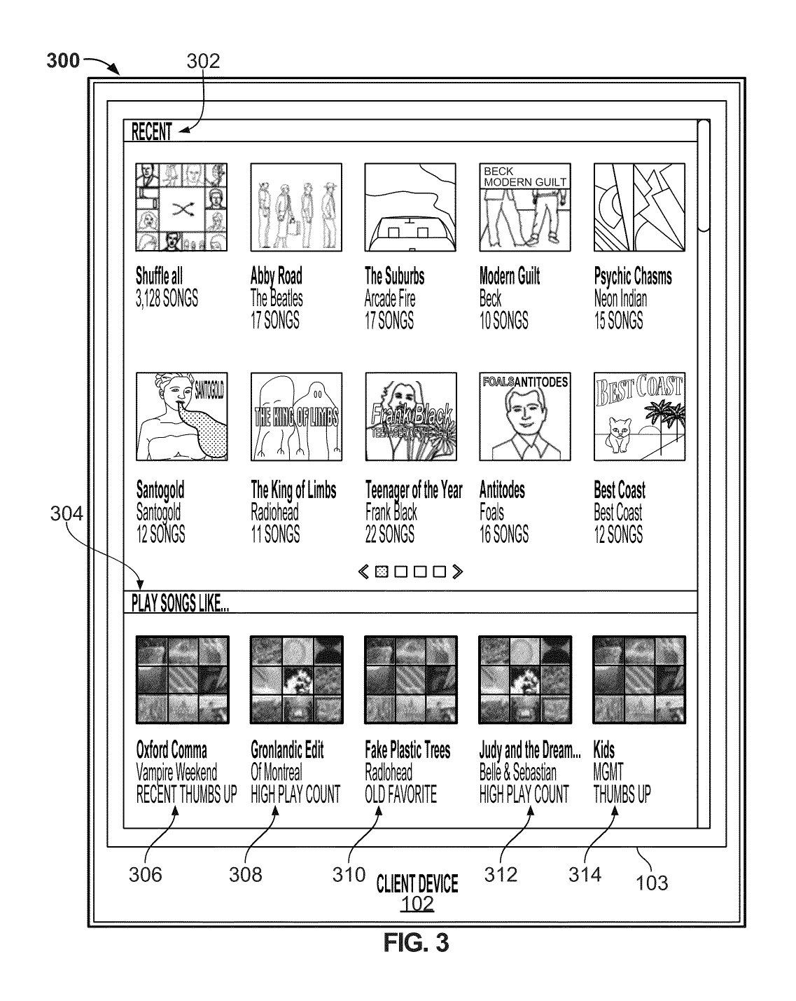

FIG. 3 is a block diagram illustrating an example graphical user interface (GUI) used with automatically generated music playlists, in accordance with an example embodiment of the disclosure. Referring to FIG. 3, the GUI 300 may appear on the display 103 after user A turns ON device 102 and logs into the digital media storage/management services platform offered by the media backend 106.

As seen in FIG. 3, the GUI 300 may include “Recent Purchases” portion 302 and “Play songs like . . . ” (or “Playlists”) portion 304. The “Playlists” portion may include automatically generated playlists 306, . . . , 314, based on one or more selection criteria (as described above). Each of the auto-generated playlists may include icon art representations from one or more of the songs within the specific playlist (each square art icon of the playlists 306, . . . , 314 includes nine smaller squares which represent icon art of nine songs within the playlist). Additionally, the auto-generated playlists 306, . . . , 314 may be different every time user A turns ON the device 102 or logs into the digital media storage/management services platform offered by the media backend 106. User A may also be given an option to permanently save one or more of the playlists 306, . . . , 314 for repeat use in the future.

Additionally, user A may have an option to delete one or more of the auto-generated playlists 306, . . . , 314 or generate one or more additional playlist automatically (after one is deleted) or upon demand. In either of these cases, a request for a new playlist may be communicated to the media backend 106 to generate a new automatic playlist, as described above in reference to FIG. 2.

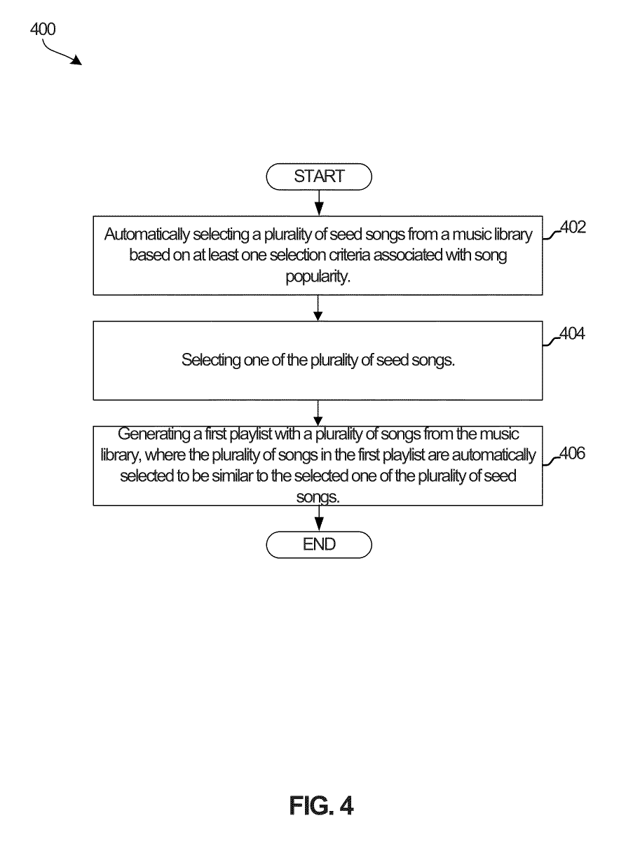

FIG. 4 is a flow chart illustrating example steps of a method for generating a playlist, in accordance with an example embodiment of the disclosure. Referring to FIGS. 1, 2, and 4, the method 400 may start at 402, when a plurality of seed songs (e.g., 210, . . . , 212) may be automatically selected from a music library (e.g., 108) based on at least one selection criteria associated with song popularity (e.g., selection criteria used by the seed filter 202). At 404, one of the plurality of seed songs (e.g., seed 210) may be selected (e.g., randomly or otherwise, by the selector module 204). At 406, a first playlist (e.g., 224) may be generated with a plurality of songs (DMIs 216, . . . , 218 and seed 210) from the music library (e.g., DMIs 120, . . . , 122 in digital media library 108). The plurality of songs in the first playlist may be automatically selected (e.g., by the similarity engine 206) to be similar to the selected one of the plurality of seed songs.

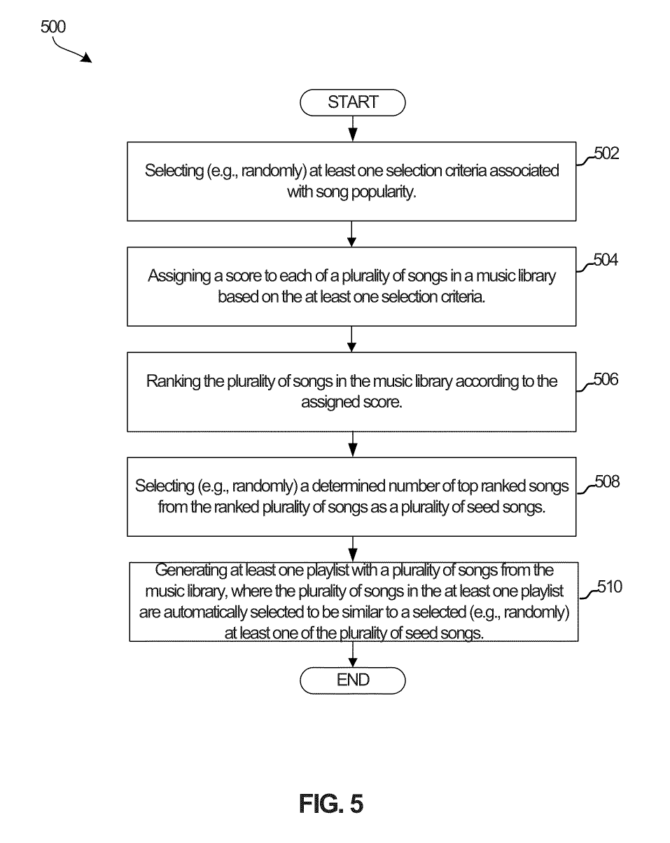

FIG. 5 is a flow chart illustrating example steps of another method for generating a playlist, in accordance with an example embodiment of the disclosure. Referring to FIGS. 1, 2 and 5, the method 500 may start at 502, when at least one selection criteria associated with song popularity may be selected (e.g., randomly or otherwise, by the seed filter 202). At 504, a score (or weight) may be assigned (e.g., by the seed filter 202) to each of a plurality of songs (DMIs 120, . . . , 122) in a music library (108) based on the at least one selection criteria. At 506, the plurality of songs (DMIs 120, . . . , 122) in the music library (108) may be ranked according to the assigned score. At 508, a determined number of top ranked songs may be selected from the ranked plurality of songs as a plurality of seed songs (e.g., seed list 208 selected by the seed filter 202). At 510, at least one playlist may be generated (e.g., 224, . . . , 226) with a plurality of songs from the music library. The plurality of songs (e.g., 216, . . . , 218) in the at least one playlist (e.g., 224) may be automatically selected (e.g., by the similarity engine 206) to be similar to a selected at least one of the plurality of seed songs (e.g., a randomly selected one, such as seed 210).

Other implementations may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for generating a playlist.

Accordingly, the present method and/or system may be realized in hardware, software, or a combination of hardware and software. The present method and/or system may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present method and/or apparatus has been described with reference to certain implementations, it will be understood by those skilled in the art that various changes may be made and equivalents may be substituted without departing from the scope of the present method and/or apparatus. In addition, many modifications may be made to adapt a particular situation or material to the teachings of the present disclosure without departing from its scope. Therefore, it is intended that the present method and/or apparatus not be limited to the particular implementations disclosed, but that the present method and/or apparatus will include all implementations falling within the scope of the appended claims.

What is claimed is:

1. A method for generating a playlist, the method comprising:
automatically selecting a plurality of seed songs from a music library based on at least one selection criteria associated with song popularity, wherein the at least one selection criteria is selected from a plurality of available selection criteria;
selecting one of the plurality of seed songs; and
generating a first playlist with a plurality of songs from the music library, wherein the plurality of songs in the first playlist are automatically selected to be similar to the selected one of the plurality of seed songs.

2. The method according to claim 1, wherein the at least one selection criteria comprises one or more of a highest song rating, frequency of song playback within a determined time period, recent song purchase, and social media posting by a user regarding a song from the music library.

3. The method according to claim 1, comprising:
generating a second playlist from the music library based on another selected one of the plurality of seed songs; and
communicating the first and second playlists to a user device for display.

4. The method according to claim 1, comprising:
generating a combined music art icon of the first playlist for display at a user device, the combined music art icon comprising music art for each of the plurality of songs in the first playlist.

5. The method according to claim 4, comprising:
causing display of the combined music art icon at the user device, wherein the display comprises an indication of the at least one selection criteria and the selected one of the plurality of seed songs.

6. The method according to claim 1, comprising:
assigning a score to each song in the music library based on whether the song satisfies the at least one selection criteria.

7. The method according to claim 6, comprising:
selecting the plurality of seed songs by selecting a determined number of songs from the music library based on a maximum assigned score.

8. The method according to claim 1, comprising:
sending a user notification of the generated first playlist to a user device; and
in response to an input from the user, saving the first playlist in memory for subsequent use.

9. The method according to claim 8, comprising:
generating a new playlist with a plurality of songs from the music library, wherein:
the plurality of songs in the new playlist are automatically selected to be similar to a new selected one of the plurality of seed songs; and
the generating of the new playlist takes place upon restarting of the user device.

10. The method according to claim 1, wherein:
the at least one selection criteria is selected randomly from the plurality of available selection criteria; and
the selecting of one of the plurality of seed songs is performed randomly.

11. A system for generating a playlist, the system comprising:
a network device, the network device being operable to:
automatically select a plurality of seed songs from a music library based on at least one selection criteria associated with song popularity, wherein the at least one selection criteria is selected from a plurality of available selection criteria;
select one of the plurality of seed songs; and
generate a first playlist with a plurality of songs from the music library, wherein the plurality of songs in the first playlist are automatically selected to be similar to the selected one of the plurality of seed songs.

12. The system according to claim 11, wherein the at least one selection criteria comprises one or more of a highest song rating, frequency of song playback within a determined time period, recent song purchase, and social media posting by a user regarding a song from the music library.

13. The system according to claim 11, wherein the network device is operable to:
generate a second playlist from the music library based on another selected one of the plurality of seed songs; and
communicate the first and second playlists to a user device for display.

14. The system according to claim 11, wherein the network device is operable to:
generate a combined music art icon of the first playlist for display at a user device, the combined music art icon comprising music art for each of the plurality of songs in the first playlist.

15. The system according to claim 14, wherein the network device is operable to:
cause display of the combined music art icon at the user device, wherein the display comprises an indication of the at least one selection criteria and the selected one of the plurality of seed songs.

16. The system according to claim 11, wherein the network device is operable to:
assign a score to each song in the music library based on whether the song satisfies the at least one selection criteria.

17. The system according to claim 16, wherein the network device is operable to:
select the plurality of seed songs by selecting a determined number of songs from the music library based on a maximum assigned score.

18. The system according to claim 11, wherein the network device is operable to:
send a user notification of the generated first playlist to a user device; and
in response to an input from the user, save the first playlist in memory for subsequent use.

19. The system according to claim 18, wherein the network device is operable to:
generate a new playlist with a plurality of songs from the music library, wherein:
the plurality of songs in the new playlist are automatically selected to be similar to a new selected one of the plurality of seed songs; and
the generating of the new playlist takes place upon restarting of the user device.

20. A method for generating a playlist, the method comprising:
selecting a plurality of selection criteria associated with song popularity, wherein at least one of the plurality of selection criteria is based on a user interaction on a social web site regarding at least one of a plurality of songs in a music library;
assigning a score to each of the plurality of songs in the music library based on the at least one selection criteria;
ranking the plurality of songs in the music library according to the assigned score;
selecting a determined number of top ranked songs from the ranked plurality of songs as a plurality of seed songs; and
generating at least one playlist with a plurality of songs from the music library, wherein the plurality of songs in the at least one playlist are automatically selected to be similar to a selected at least one of the plurality of seed songs.
